(19) United States
(12) Patent Application Publication
(10) Pub. No.: US 2013/0343848 A1
(43) Pub. Date: Dec. 26, 2013

(54) Self-Contained Truck Bed Conveyor

(71) Applicant: Timothy Wangen, Kendall, WI (US)

(72) Inventor: Timothy Wangen, Kendall, WI (US)

(21) Appl. No.: 13/926,888

(22) Filed: Jun. 25, 2013

Related U.S. Application Data
(60) Provisional application No. 61/664,009, filed on Jun. 25, 2012.

(51) Int. Cl. B60P 1/38

(52) U.S. Cl. CPC B60P 1/38
USPC 414/528

(57) ABSTRACT

The invention is directed to a self-contained conveyor belt apparatus that may be removably installed in the bed of a truck or cargo container. A frame is provided containing a belt rotatably wrapped around a plurality of drums, some freely spinning and at least one of which is powered by one or more electric motors. Electric power may be supplied by the truck's electrical systems or by a battery. The frame features a plurality of lockable tension members affixed to its outside edges such that the conveyor may be firmly retained between the walls of the truck's cargo area. A wired or wireless control unit is provided to assist users in moving cargo between the front and rear of the cargo area.

### CROSS-REFERENCE TO RELATED APPLICATIONS

This application claims priority to U.S. Provisional Application No. 61664009 filed Jun. 25, 2012, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates in general to the field of cargo conveyor systems, and in particular to the field of cargo conveyor systems installed on or in the bed of a truck's cargo area or a cargo container. It is well known that the process of loading and unloading cargo from the confined space of a truck or cargo container is labor intensive and presents a risk of damage to the cargo and injury to the worker(s) doing the loading or unloading, in the event of a handling accident. Various systems exist wherein the bed or floor of the truck or cargo container is provided with an automated conveyor belt system, which quickly moves cargo from the front to the back of the cargo area and vice versa. Using such systems, the loader(s) can load the foremost cargo first, shift it back a bit, then load some more, and so on until the cargo area is packed. In unloading, the process is repeated.

A drawback to this practice is that existing cargo conveyor belt systems are generally built into the bed or floor of a particular model of truck or container, and such systems are not commonly installed in the majority of trucks and containers. Moreover, a particular business or operator may become used to the benefits of working with a conveyor system, only to have to give up those benefits when their equipment is retired from use and a new truck or container with conveyor equipment is not readily available at a realistic cost. A solution, therefore, is to provide a floor-level truck conveyor system that may be removably installed in a truck or cargo container and re-used when old standard equipment is retired and replaced with new standard equipment.

### SUMMARY OF THE INVENTION

Accordingly, the invention is directed to a self-contained conveyor belt apparatus that may be removably installed in the bed of a truck or cargo container. A frame is provided containing a belt rotatably wrapped around a plurality of drums, some freely spinning and at least one of which is powered by one or more electric motors. Electric power may be supplied by the truck's electrical systems or by a battery. The frame features a plurality of lockable tension members affixed to its outside edges such that the conveyor may be firmly retained between the walls of the truck's cargo area. A wired or wireless control unit is provided to assist users in moving cargo between the front and rear of the cargo area.

It is an object of the invention to improve the safety of loading and loading trucks and cargo containers by providing a cargo conveyor belt system.

It is an object of the invention to reduce the risk of damaging cargo during loading and loading trucks and cargo containers by providing a cargo conveyor belt system.

It is an object of the invention to increase the efficiency of loading and loading trucks and cargo containers by providing a cargo conveyor belt system.

It is an object of the invention to provide a low cost cargo conveyor belt system that may be retrofitted to existing trucks or cargo containers.

It is an object of the invention to provide a cargo conveyor belt system that may be removed from the truck or cargo container in which it is installed and reinstalled in another truck or cargo container.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 shows a top view of the first exemplary embodiment, showing the end caps 11, tension locking mechanisms 12, belt 13, and rollers 14.

FIG. 2 shows a front view of an exemplary control panel for the first exemplary embodiment, showing the control panel 20, auto button 21, forward button 22, and reverse button 23.

FIG. 3 shows a side cross-sectional view of the first exemplary embodiment installed in a truck bed showing the truck 30 and the apparatus 31.

### DETAILED DESCRIPTION OF THE INVENTION

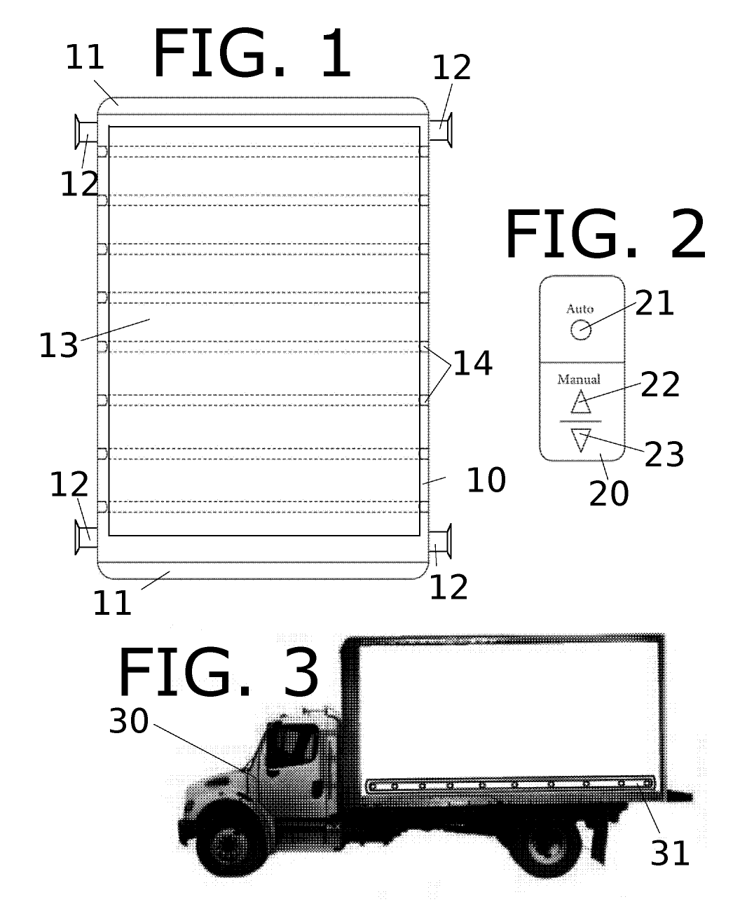

Referring now to the invention in more detail, the invention is directed to a self-contained, removable conveyor belt system for use in the cargo area of a truck or cargo container. FIG. 1. Shows a top view of the first exemplary embodiment. In the first exemplary embodiment, a rigid frame 10 is provided. The rigid frame 10 is preferably made of a material having high sheer strength and high compression strength, as heavy loads are expected to be supported by it. The frame 10 rests against the floor of the cargo area with sufficient height to keep the moving components further described below off of the floor. The frame 10 may be sized to fit a particular model of truck or cargo container; the frame 10 will preferably match the inside length of the cargo area closely, preferably allowing only a small gap between the rear end and the inside of the cargo area door. In alternative embodiments, the frame may be made shorter, for example to exactly on half or one third the width of a particular model of truck or cargo container so that multiple units may be laid end to end within the cargo area. The frame 10 will preferably be somewhat narrower than the width of the cargo area; this allows room for the tension locking mechanism described below. At the front and back outer edges of the frame 10 may be a pair of end caps 11. The end caps 11 provide rounded corners to avoid damaging the cargo or injuring workers. The end caps 11 may be made of or coated with a different material from the frame 10, for example a synthetic or natural rubber material may be preferred for its ability to absorb some shocks and vibrations at the ends of the device.

Along the outside of the long edges of the frame 10 is a plurality of tension locking mechanisms 12. The tension locking mechanisms 12 are shown as four in number, however any number may be used. The outside surfaces of the locking mechanisms 12 should preferably have a comparatively large surface area and be made of a material having a high degree of friction with a wide variety of common inside surfaces of truck wall foot plates, such as steel, aluminum, and wood. Generally, any automatic or manual mechanism wherein the length of the locking mechanism 12 may be extended and held in an extended position until released may be used, and many such systems are known in the prior art. Broadly, the frame 10 is held removably in place at the base of the cargo area by friction.

Rotatably affixed within and across the width of the frame 10 is a plurality of rollers 14 or bogie wheels. The rollers are expected to support substantial weight, and should therefore be constructed of or disposed about axles of high sheer strength material, such as steel. Some of the rollers 14 may be freely rotating, others may be driven by one or more electric motors (such electric drive systems being well-known in the prior art). Power for the motors may be provided by a battery or by the vehicle's electrical system. Wrapped tightly around the rollers 14 is a belt 13, preferably made of a reinforced vinyl or other high tensile strength material. The belt is rotated and supported by the rollers 14 to move cargo between the front and rear of the cargo area. FIG. 3 shows a cross sectional side view of the cargo area of a truck 30 having the first exemplary embodiment 31 installed therein.

A digital or analog electronic control system is provided wherein the motor speed and direction are set. Such control circuits are well known in the prior art. FIG. 2 shows an exemplary control panel 20, allowing for automated operation, or for manual forward and reverse operation. Automated operation may be activated by an auto button 21 and may be equivalent to continuous operation in one direction or the other (for example continuous unloading in conjunction with a roller ramp), or a plurality of sensors may be added to allow for feedback in automated functions, such as carrying a load from the front to the back, and then stopping. Manual forward and reverse may be activated by a forward button 22 and reverse button 23, which may be assigned to opposite terminals of a rocker switch.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A conveyor belt system comprising:
(a) a rigid frame;
(b) said rigid frame being rectangular in shape;
(c) a pair of end caps;
(d) each of said end caps being affixed to opposing edges of said rigid frame;
(e) a plurality of tension locking mechanisms;
(f) said locking mechanisms being affixed to the exterior of said rigid frame;
(g) a plurality of rollers;
(h) said plurality of rollers being rotatably mounted within said rigid frame in a manner transverse to opposing edges of said rigid frame;
(i) a belt disposed around said rollers at sufficient tension to be driven in rotation by said rollers;
(j) a motor control panel; and
(k) at least one of said plurality of rollers being motor-driven and controlled by said motor control panel;
whereby said rigid frame may be removably paced on the bed of a truck and releasably retained there by said tension locking mechanisms.

2. The conveyor belt system of claim 1 wherein said control panel has actuatably mounted thereon an auto button, a forward button, and a reverse button.

3. The conveyor belt system of claim 2 wherein said auto button is electronically mapped to a mode of operation wherein said belt is driven by said rollers to move an identified load from a first position to a second position over said rigid frame.

4. The conveyor belt system of claim 1 wherein said rigid frame is sized to fit within the bed of a particular model of truck.

5. The conveyor belt system of claim 1 wherein said rigid frame is made of steel.

6. The conveyor belt system of claim 1 wherein said rollers are made of steel.

7. The conveyor belt system of claim 1 wherein said end caps are made of steel covered by one of the group of natural rubber or synthetic rubber.

8. The conveyor belt system of claim 1 wherein said belt is made of reinforced vinyl.

9. The conveyor belt system of claim 3 wherein:
(a) said rigid frame is sized to fit within the bed of a particular model of truck;
(b) said rigid frame is made of steel;
(c) said rollers are made of steel;
(d) said end caps are made of steel covered by one of the group of natural rubber or synthetic rubber; and
(e) wherein said belt is made of reinforced vinyl.

10. The conveyor belt system of claim 1 wherein:
(a) said rigid frame is sized to fit within the bed of a particular model of truck;
(b) said rigid frame is made of steel;
(c) said rollers are made of steel;
(d) said end caps are made of steel covered by one of the group of natural rubber or synthetic rubber; and
(e) wherein said belt is made of reinforced vinyl.
